(19) United States
(12) Patent Application Publication
(10) Pub. No.: US 2013/0019586 A1
(43) Pub. Date: Jan. 24, 2013

(54) PROPULSION METHOD AND DEVICE COMPRISING A LIQUID OXIDANT AND A SOLID COMPOUND

(71) Applicants: Pierre Yvart, Vert Le Petit (FR); Pierre-Guy Amand, Paris (FR)

(72) Inventors: Pierre Yvart, Vert Le Petit (FR); Pierre-Guy Amand, Paris (FR)

(73) Assignee: HERAKLES, Le Haillan (FR)

(21) Appl. No.: 13/518,282

(22) PCT Filed: Dec. 21, 2010
(86) PCT No.: PCT/FR2010/052848

§ 371 Date: Oct. 2, 2012

(30) Foreign Application Priority Data
Dec. 21, 2009 (FR) 0959314

(51) Int. Cl. F02K 9/72; F02K 9/80; F02K 9/50

(52) U.S. Cl. 60/243; 60/221; 60/253; 60/251; 60/259

(57) ABSTRACT

One subject of the present invention is a propulsion method comprising:
the injection, into at least one combustion chamber (1), of at least one liquid oxidizer (OX) and of hydrogen (H₂);
the combustion of said at least one liquid oxidizer (OX) and hydrogen (H₂), in said at least one combustion chamber (1), for the generation of combustion gases; and
expulsion of said combustion gases.

Said process comprises, upstream of said injection:
the generation of at least one portion of said hydrogen (H₂), advantageously of all said hydrogen (H₂), from at least one solid compound (5′); said generation from said at least one solid compound (5′) comprising a combustion reaction between said at least one solid compound (5′) chosen from alkali metal borohydrides, alkaline-earth metal borohydrides, borazane, polyaminoboranes and mixtures thereof and an oxidizing charge (5″).

Another subject of the present invention is a propulsion device suitable for the implementation of said method.

One subject of the present invention is a method of propulsion generally carried out with thrust modulation. Said method is based on the injection, into a combustion chamber, of a liquid oxidizer and of hydrogen and the combustion of said liquid oxidizer and hydrogen, said combustion generating propellant gases.

Another subject of the present invention is a propulsion device. Said device is particularly suitable for the implementation of said method. Said device is capable of existing in several embodiment variants.

The technical field of the invention is that of motors for propulsion of rockets and missiles, that of propulsion modules for trajectory correction and/or that of modulation of the main thrust of missiles or rockets. It also relates to the propulsion of drones and microdrones. A propellant load of solid propellant (of ammonium perchlorate/metallic charge/binder type) is generally used in these systems.

Motors with thrust modulation have been widely studied and exist in several forms.

Solid-propellant motors have high thrusts for reduced dimensions. Their simplicity of design and their availability of use also constitute advantages. Those skilled in the art have therefore developed pyrotechnic propulsion devices using solid-propellant motors, with thrust modulation via valving of the throat of the nozzle. The device, as described in U.S. Pat. No. 3,948,042, thus uses a load of solid propellant discharging by means of a controlled variable-section nozzle. The variation of the nozzle throat area modifies the pressure in the combustion chamber of the propulsion unit and consequently the flow of the propellant and the thrust of the motor.

Hybrid propulsion methods, comprising the injection of an oxidizer such as oxygen, nitrogen peroxide, aqueous hydrogen peroxide solution or more commonly liquid or gaseous nitrogen protoxide, in a combustion chamber containing a solid fuel, usually a hydrocarbon-based polymer, such as a polyester, polycarbonate, polyether, or polyurethane have furthermore been described. Patent application US 2005/0034447 thus describes the use of polyoxymethylene as a solid fuel. Patent application WO 00/09880 describes another type of solid fuel comprising a metal hydride and a specific polymeric binder (“ROMP-based polymer”) of said hydride. The combustion of this solid fuel is studied in the presence of oxygen and compared to that of a metal hydride incorporating a PBHT-based binder.

U.S. Pat. No. 6,250,072 and patent application US 2003/0136110 also describe the injection of a liquid oxidizer into a chamber of a hybrid propulsion device containing a polymeric solid fuel.

U.S. Pat. No. 4,835,959 itself relates to an architecture of liquid oxidizer injectors in a hybrid motor.

There are also storable biliquid methods and devices, the liquids being, for example, MMH (monomethylhydrazine)/N₂O₄ (nitrogen tetroxide), or H₂O₂/hydrocarbon such as kerosene or methane, which provide a high specific impulse level and a capacity for thrust modulation. These devices are often preferred to those of the two preceding types (solid-propellant motors with valving of the throat of the nozzle and hybrid propulsion devices) for propulsion applications with thrust modulation.

The implementation of the hybrid or biliquid methods (the use of the devices) of the prior art generate relatively polluting combustion products (HCl, NOx, CO, NH₃, particles). It would be opportune to provide devices that do not generate such products. Furthermore, hybrid methods use a solid fuel, such as a hydrocarbon-based polymer, which, when the device (not used) associated with the method is dismantled at end-of-life, is difficult to recycle and biliquid methods use a reducing compound, such as MMH or a hydrocarbon, which may present dangers for man and the environment.

Of course, those skilled in the art also know that hydrogen can be used as a (non-polluting) reducing agent for propulsion applications. Indeed, said hydrogen has the advantage of being nontoxic and safe for the environment. Thus, cryogenic propulsion (H₂/O₂) is one well-known alternative, which makes it possible to achieve a high level of specific impulse. Nevertheless, cryogenics requires heavy refrigeration devices, which are not compatible with most of the applications in question in the present invention. Furthermore, the storage of pressurized hydrogen in a metallic tank or more recently in a tank made of carbon fibers has a low structural index and a dangerousness that reasonably excludes its use in storable propulsion systems.

A propulsion device using a solid hydrogen-generating compound is described in U.S. Pat. No. 3,350,887. This is a rocket motor constituted of a combustion chamber comprising, within it, on the one hand, a liquid oxidizer tank, and on the other hand, a solid hydrogen generator, both flowing into said combustion chamber via respectively a first line and a nozzle. Said solid hydrogen generator also flows directly (without valving means) into said tank via a second line, enabling the pressurization of said tank, in order to drive the liquid oxidizer into the combustion chamber via said first line. Said solid hydrogen generator contains a cylindrical load with a central channel of a metal hydride. A solid propellant charge is placed inside the channel of the load. Its role is to initiate the endothermic decomposition of said load, the pressurization of the liquid oxidizer tank, and also to introduce hot gases into the combustion chamber, in order to ignite the mixture injected into the chamber by the tank and the solid hydrogen generator. The heat produced by the combustion of said injected mixture then provides the energy input (by thermal conduction through the wall of the generator) necessary for the endothermic decomposition of the solid load (this solid load is not suitable for auto-ignition). It is obvious for those skilled in the art that the operation of such a device is difficult to regulate. Said operation is furthermore capable of resulting in a divergent runaway of the device. Moreover, said device is not suitable for operation in thrust modulation. Firstly, it is not equipped with a valve that makes it possible to regulate the exiting fluid flow rates. Secondly, after the combustion of the charge of solid propellant (initiator), it is therefore the heat produced by the combustion chamber that ensures the endothermic decomposition of the hydride load. Under these conditions, a drop in the temperature of the combustion chamber, which would be linked to a low thrust modulation phase, could induce stoppage of the endothermic decomposition of the load, which load it would subsequently be impossible to reinitiate, the propellant charge having been consumed. It is clear that this motor extinguishing phenomenon, without possible reignition, is even more inexorable, if the motor is subject to extinguishing at zero thrust inducing a rapid drop in the temperature in the combustion chamber. Finally, the device does not make it possible, for example, to attain low-thrust phases by stopping the supply of liquid oxidizer while continuing to produce hot hydrogen contributing to the thrust.

In an entirely different context relating to electricity production, those skilled in the art know solid compounds, used as a source of hydrogen, for supplying fuel cells. Said solid compounds, capable of supplying fuel cells, are compounds having a high content of hydrogen (borohydrides, borazane, etc.) that release their hydrogen via hydrolysis, thermal decomposition or combustion reactions. The hydrogen generators using these solid compounds have a better structural index for hydrogen production than the pressurized hydrogen tanks. Such solid compounds are especially described in patent application WO 2009/138629 (borazane and polyaminoboranes capable of generating hydrogen via combustion or thermal decomposition), in patent applications EP 1 249 427, EP 1 405 824, EP 1 496 035 and EP 2 014 631 (alkali and alkaline-earth metal borohydrides capable of generating hydrogen via combustion with an inorganic oxidizing agent), in patent applications US 2007/0189960, US 2008/216906 and U.S. Pat. No. 6,746,496 (alkali and alkaline-earth metal borohydrides capable of generating hydrogen via hydrolysis).

Those skilled in the art seek propulsion methods and devices that are suitable in particular for operation with thrust that can be adjusted over a high amplitude, having a high structural index, that are safe and are not very toxic or not toxic at all for man and the environment, using storable fuel/oxidizer compounds.

In reference to these specifications, according to a first subject thereof, the invention relates to an original propulsion method.

Said original propulsion method comprises, conventionally:
the injection, into at least one combustion chamber, of at least one liquid oxidizer and hydrogen;
the combustion of said at least one liquid oxidizer and hydrogen, in said at least one combustion chamber, for the generation of combustion gases; and
the expulsion of said combustion gases.

Originally, it comprises, upstream of said injection:
the generation of at least one portion of said hydrogen, advantageously of all of said hydrogen, from at least one solid compound; said generation from said at least one solid compound comprising a combustion reaction between said at least one solid compound chosen from alkali metal borohydrides, alkaline-earth metal borohydrides, borazane, polyaminoboranes and mixtures thereof and an oxidizing charge.

The combustion reaction between said at least one solid compound and said oxidizing charge, once initiated, is an auto-ignition reaction identical to that obtained for standard solid propellants containing, within them, oxidizing and reducing elements that enable their auto-ignition without external heat input and without additional injection of oxidizer and/or of fuel.

Said oxidizing charge is advantageously chosen from strontium nitrate (Sr(NO₃)₂), ammonium dinitramide (ADN: NH₄N(NO₂)₂), ammonium perchlorate (NH₄ClO₄), ammonium nitrate (NH₄NO₃) and mixtures thereof.

The method of the invention is characterized by at least one of its sources of hydrogen, advantageously by its source (its sole source) of hydrogen. Said hydrogen is generated, at least partly, advantageously completely, from at least one solid compound. It is thus stored, at least partly, advantageously completely, in solid form, more specifically in the form of at least one solid precursor. Said solid precursor(s) is (are) suitable for generating hydrogen. It (they) is (are) generally suitable for generating a gaseous reducing fluid, predominantly (by volume) constituted of hydrogen. A sole solid compound (several solid compounds, of the same nature or of different natures) is (are) thus capable of acting as hydrogen precursor(s).

It is to the credit of the inventors to propose, within the context of propulsion, solid compounds as a source of hydrogen, especially solid compounds already used as a source of hydrogen, but in a completely different context (that of supplying fuel cells for the production of electricity (see above)). The novel propulsion method resulting therefrom is high-performance. It meets the desired criteria, thus competing with the propulsion methods, especially with thrust modulation, of the prior art.

It is more specifically to the credit of the inventors to propose, as a source of hydrogen, solid compounds (chosen from alkali metal borohydrides, alkaline-earth metal borohydrides, borazane, polyaminoboranes and mixtures thereof) which, via auto-ignition with an oxidizing charge, generate high-temperature gases; the combustion chamber then functioning with said gases and the liquid oxidizer in hypergolic combustion, hence the possibility of extinguishing and reigniting at will, hence the possibility of easily managing the thrust modulation (see below).

One portion of the hydrogen injected, when the latter is not completely generated from at least one solid compound, may originate, for example, from a store of pressurized gaseous hydrogen or from a store of cryogenic liquid hydrogen.

Preferably, the hydrogen generated from at least one solid compound, within the context of the implementation of the method of the invention, is generated from borazane (hydrogen precursor), combusted with an oxidizing charge, advantageously consisting of Sr(NO₃)₂.

The generation of hydrogen from at least one solid compound (hydrogen source or precursor) is generally accompanied by the generation of other gaseous species such as H₂O, HCl, NO₂, NH₃, N₂, etc. Within the context of the implementation of the method of the invention, in particular from hydrogen precursors identified above, a reducing gas stream is generated that generally comprises at least 85% by volume of hydrogen and at most 5% by volume of other gaseous species such as H₂O, HCl, NO₂, NH₃, N₂, etc.

It is not excluded for the solid products generated, together with said hydrogen (with said reducing gas stream), from said at least one solid compound, to also be injected into the combustion chamber in order to be expelled therefrom with the combustion gases. Thus, the solid products resulting from the generation of hydrogen are disposed of as they are formed. The inert mass of the device is thus reduced as the hydrogen is consumed.

Said at least one liquid oxidizer is advantageously chosen from aqueous solutions of nitric acid, hydrogen peroxide, nitrogen peroxide, hydroxylammonium nitrate (HAN), ammonium dinitramide (ADN), ammonium nitroformate and mixtures thereof (when the compounds are compatible with one another); said at least one liquid oxidizer highly advantageously consists of an aqueous solution of hydrogenperoxide.

Aqueous solutions of hydrogen peroxide are particularly preferred, especially due to their safety for man and his environment. Indeed, the combustion of hydrogen peroxide with hydrogen generates water and therefore has no environmental impact.

Said aqueous solutions of hydrogen peroxide advantageously have a hydrogen peroxide content of greater than 30% by weight; they very advantageously have such a content greater than 80%, or even 95% or 98% by weight.

According to one particularly preferred embodiment variant, the propulsion method of the invention comprises the generation of hydrogen from borazane, borazane combusted with an oxidizing charge, advantageously consisting of strontium nitrate, and the injection of said generated hydrogen and of an aqueous solution of hydrogen peroxide into at least one combustion chamber.

The propulsion method of the invention is particularly suitable for an implementation with thrust modulation. Said thrust modulation is advantageously obtained by adjusting the rate of injection of the at least one liquid oxidizer into the combustion chamber and/or the rate of injection of the hydrogen, generated (at least partly, advantageously completely) from the at least one solid compound, into the combustion chamber.

The method of the invention is most advantageous in propulsion applications with modulation. Indeed, the production by auto-ignition of gases at high temperature (for example at 1360 K for a compound based on 60% of borazane and 40% of strontium nitrate) by the solid compound, essentially hydrogen, enables operation in hypergolic combustion of the combustion chamber in the presence of the liquid oxidizer. Thus, even if the supply of the combustion chamber is stopped for a long time, during a modulation phase without thrust, the reignition of the combustion in the combustion chamber is then possible by contact between the high-temperature gases generated by the solid compound and the liquid oxidizer once again injected into the combustion chamber.

Moreover, it is also advantageous to be able to manage low-thrust phases, by stopping the flow of liquid oxidizer into the combustion chamber; the residual thrust then being provided by the generation of hydrogen by the solid compound.

Furthermore, when the combustion chamber is ignited (i.e. when the liquid oxidizer vaporizes when it is injected into said combustion chamber), if the injection of the hydrogen into said combustion chamber is not sonic (i.e. when the pressure at which auto-ignition takes place for the production of hydrogen is linked to the pressure in the combustion chamber), it is possible to manage the flow of hydrogen injected into the combustion chamber by varying the pressure in said combustion chamber, for example by modifying the rate of injection of the liquid oxidizer into said combustion chamber or by modulating the rate of expulsion of the gases from said combustion chamber. Thus, an increase of pressure in the combustion chamber induces an increase (of the pressure) of the auto-ignition for the generation of hydrogen: the combustion rate of the solid compound and of the oxidizing charge, and therefore the production of hydrogen, increase as a result (the combustion rate of propellant loads being driven by the pressure, according to the Paul Vieille's law of operation).

According to a second subject thereof, the present invention relates to a propulsion device which comprises:
at least one combustion chamber equipped with at least one nozzle,
a device for supplying said at least one combustion chamber with at least one liquid oxidizer, and
a device for supplying said at least one combustion chamber with hydrogen.

Characteristically, said device for supplying said at least one combustion chamber with hydrogen comprises at least one hydrogen generator containing at least one solid compound chosen from alkali metal borohydrides, alkaline-earth metal borohydrides, borazane, polyaminoboranes and mixtures thereof and an oxidizing charge suitable for a combustion of said solid compound (thus generating said hydrogen); said hydrogen generator being connected, on the one hand, to said at least one combustion chamber via a valve and, on the other hand, to the outside, via an advantageously controlled leakage means.

Said device for supplying said at least one combustion chamber with hydrogen therefore comprises at least one hydrogen generator containing at least one solid compound capable of generating hydrogen by auto-ignition (reaction between said at least one solid compound chosen from alkali metal borohydrides, alkaline-earth metal borohydrides, borazane, polyaminoboranes and mixtures thereof and an oxidizing charge). Said at least one hydrogen generator discharges (is connected by a line), via a valve, into (to) at least one combustion chamber. An advantageously controlled means of leaking hydrogen to the outside is associated with said at least one solid hydrogen generator. It may be arranged on the line connecting said gas generator to said combustion chamber. It may be a supplementary member provided in the structure of the valve mentioned above. It may also be a relief valve arranged on said generator or on the line into which said generator discharges. Irrespective of its exact embodiment, said gas (mainly H₂) leakage means is provided so as to be able to control the internal pressure of said at least one generator when said valve (the valve for delivery of said at least one generator into the combustion chamber) is partially or completely closed, in the modulation phases, then not enabling all of the hydrogen, generated by the solid compound in auto-ignition, to flow into the combustion chamber.

It has been understood that the device of the invention, as specified above, is suitable for the implementation of the propulsion method with thrust modulation.

The device for supplying the at least one combustion chamber with hydrogen is capable of existing in many embodiments: a single generator containing a single solid compound, source of hydrogen, a single generator containing a mixture of solid compounds, sources of hydrogen, several generators containing the same solid compound, several generators containing different solid compounds, etc. It may also comprise at least one pressurized gaseous hydrogen tank and/or at least one cryogenic liquid hydrogen tank equipped with an injection pump, discharging, optionally via a valve, into at least one combustion chamber.

The at least one hydrogen generator may or may not be provided with a particulate filter. Such a filter aims to prevent the passage of solid reaction products from said at least one generator to the combustion chamber(s).

The device for supplying the at least one combustion chamber with at least one liquid oxidizer is generally constituted of one or more pressurized tanks, discharging via a valve into said at least one combustion chamber. It is also capable of existing in several embodiments: a single tank containing an oxidizer or a mixture of oxidizers, several tanks containing the same oxidizer or oxidizers of different nature, etc.

According to one advantageous variant, the pressurization of at least one liquid oxidizer tank is provided by a portion of the gases produced (predominantly hydrogen) in said at least one hydrogen generator, then connected to said at least one tank via a valve. Said one tank comprises, in this context, advantageously a deployable membrane separating, in said liquid oxidizer tank, the injection volume of the gases produced (predominantly hydrogen) in said at least one hydrogen generator and the volume containing said oxidizer. Said deployable membrane provides a physical separation, in said liquid oxidizer tank, between a portion of the gases produced (predominantly hydrogen) in said at least one hydrogen generator and said liquid oxidizer; it makes it possible to avoid any untimely reaction in the tank between said gases and said liquid oxidizer.

The base device of the invention comprises a combustion chamber, a hydrogen generator and a liquid oxidizer tank which are connected to said combustion chamber. Said hydrogen generator is only connected, according to a first variant, to (only discharges into) said combustion chamber. According to a second variant, it is connected (it discharges) both to (into) said chamber and to (into) the liquid oxidizer tank.

The device is suitable for the implementation of the propulsion method (with hypergolic combustion) described above and does not therefore require ignition means mounted on the at least one combustion chamber. It is not however excluded that at least one ignition means be included on said combustion chamber in order to control as best possible the instant of at least one ignition, for example during the takeoff of the vehicle equipped with the device of the invention, where it is necessary to attain a maximum thrust in a very brief and perfectly synchronized time.

The device includes one or more ignition means in order to initiate the reaction in the at least one hydrogen generator.

The valves present are advantageously controlled by the central control unit of the vehicle (rocket, missile, etc.) equipped with the device of the invention. Said valves enable the implementation of the propulsion with thrust modulation. They are more or less open depending on the thrust levels or orientations required.

According to the third subject thereof, the invention relates to a propulsion unit, the structure of which includes at least one propulsion device of the invention.

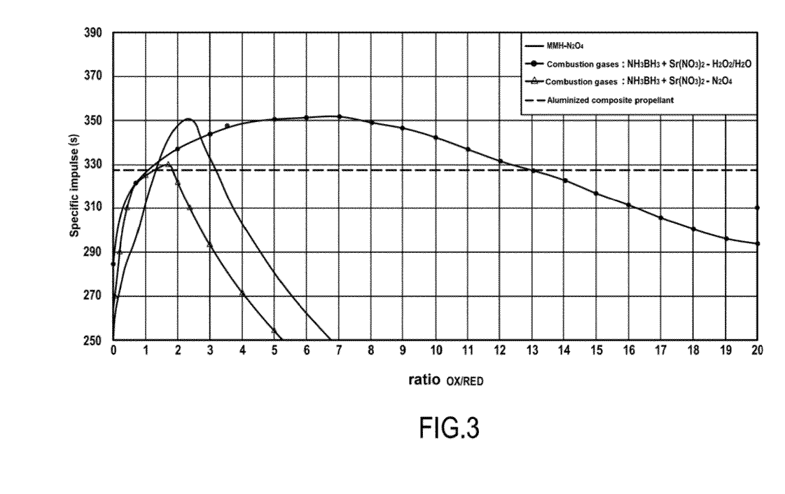

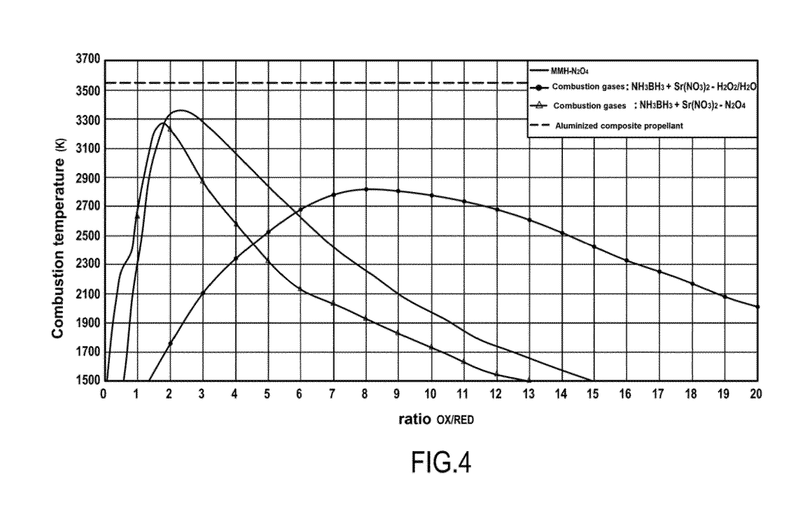

It is now proposed to illustrate, in no way limitingly, the invention in its device and method aspects by the appended figures and examples below. Two exemplary embodiments of the method of the invention are more particularly described with reference to FIGS. 3 and 4.

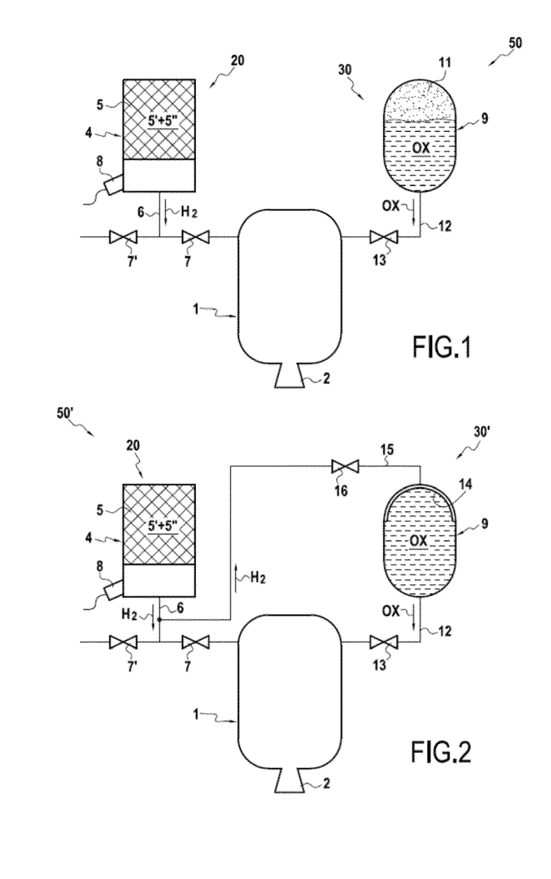

FIG. 1 schematically shows a propulsion device of the invention (first variant).

FIG. 2 schematically shows a propulsion device of the invention (second variant).

FIG. 3 shows the curves of calculated specific impulse as a function of the mix ratio, injected into the combustion chamber; MMH/N₂O₄ mix of the prior art (curve with no marker), mix of gases produced (predominantly H₂) by the combustion of a solid compound (borazane (NH₃BH₃)) with Sr(NO₃)₂/N₂O₄ (curve with triangular markers (example 2)) and mix of gases produced (predominantly H₂) by the combustion of a solid compound (borazane (NH₃BH₃)) with Sr(NO₃)₂/an aqueous solution of hydrogen peroxide (H₂O₂/H₂O at 85% by weight of H₂O₂) (curve with solid round markers (example 1)).

FIG. 4 shows the combustion temperature curves for the same mixes as those from FIG. 1.

The device 50 according to the invention, in its preferred base variant shown in FIG. 1, comprises a combustion chamber 1 provided with a nozzle 2, a device 20 (with hydrogen generator 4) for supplying said combustion chamber 1 with hydrogen and a device 30 (with tank 9 of liquid oxidizer OX) for supplying said combustion chamber 1 with liquid oxidizer OX.

The hydrogen generator 4 comprises a solid block 5 constituted of a solid compound 5′ capable of generating hydrogen in mixture with an oxidizing charge 5″ (5=5′+5″), the combustion of the block 5 (the combustion of the solid compound 5′ with the oxidizing charge 5″) generates hydrogen. Said hydrogen generator 4 is connected to said combustion chamber 1 by means of a line 6 comprising a valve 7, thus enabling the hydrogen generated to be injected into the combustion chamber 1. The line 6 also comprises a controlled means 7′ (in the variant represented, another valve) for leaking to the outside the hydrogen produced by the hydrogen generator 4, making it possible to control the pressure inside said hydrogen generator 4 when the valve 7 is partially or completely closed. Said hydrogen generator 4 is equipped with a device 8 for ignition of the combustion of the block 5.

According to the variant represented, the hydrogen generator 4 and the line 6 are not provided with a nozzle or equivalent and the operating pressure of said hydrogen generator 4 is linked to the pressure in said combustion chamber 1 (when the valve 7 is open). It is then possible to control the operation of the hydrogen generator 4 by varying the flow of liquid oxidizer OX injected into the combustion chamber 1. According to another variant that is not represented, the hydrogen generator or the line are provided with a nozzle or equivalent, that is to say that the operation of the hydrogen generator is independent of the pressure conditions in the combustion chamber.

The tank 9 of liquid oxidizer OX comprises an ullage space 11 (for example a nitrogen or helium ullage space). It is kept under pressure. It is connected to the combustion chamber 1 by means of a line 12 and a valve 13, making it possible to inject the liquid oxidizer OX into said combustion chamber 1.

FIG. 2 shows another device of the invention. In said device all of the elements of the device from FIG. 1 are found, except for the ullage space 11 which is replaced by a deployable membrane 14. Moreover, an additional line 15 provided with a valve 16 makes it possible to inject a portion of the gases produced (predominantly hydrogen) by the hydrogen generator 4 into the space separating the deployable membrane 14 from the liquid oxidizer OX contained in the tank 9 (said space being destined to be created and to expand). The deployment of the membrane 14 under the effect of the pressurization of the gases injected via the valve 16 ensures the injection of the liquid oxidizer OX into the combustion chamber 1.

The following examples, with thermodynamic calculations, show the advantage of the invention (of the method of the invention) from the point of view of ballistic performance (method of the invention compared to the biliquid methods of the prior art).

Said thermodynamic calculations were carried out for the following thermodynamic conditions:
pressure in the combustion chamber: 5 MPa,
nozzle expansion ratio: 80,
external pressure: 0.06 MPa (quasi-vacuum).

### EXAMPLE 1

Example 1 relates to a propulsion method implemented according to the preferred variant of the invention in a device of the type of that of FIG. 1. Said device comprises on the one hand, a hydrogen generator (within which said hydrogen is generated by combustion of NH₃BH₃ (60% by weight) (solid compound that is a source of hydrogen) with Sr(NO₃)₂ (40% by weight) (oxidizer)) and, on the other hand, a liquid oxidizer tank (said liquid oxidizer consisting of an aqueous solution of hydrogen peroxide, containing 85% by weight of H₂O₂). Said method therefore comprises said generation of hydrogen (more exactly that of combustion gases predominantly constituted of hydrogen) and the injection of said hydrogen and liquid oxidizer.

It is considered that only the gaseous products generated by the combustion: solid borazane compound with Sr(NO₃)₂, are introduced into the combustion chamber.

Table 1 below indicates the gaseous species produced (subsequently referred to as “gaseous product A”) in the hydrogen generator, their molar proportions measured by combustion tests in a gas generator with analysis of the gases. This table also indicates the weight percentages of said species, as introduced into the calculation of the ballistic performances, during the combustion with the liquid oxidizer (the most minor species, measured in the gas generator, having been disregarded in said calculation).

TABLE 1
60% NH₃BH₃ + 40% Sr(NO₃)₂

| | | Weight % used for the |
|---|---|---|
| | Volume % or molar % | thermodynamic calculation |
| | measured in a | of the example |
| | manometer chamber | (gaseous product A) |
| H₂ | 92.446 | 45.7 |
| N₂ | 6.341 | 43.6 |
| B₃N₃H₆ | 0.219 | 4.3 |
| O₂ | 0.524 | 4.1 |
| CO | 0.110 | 0.8 |
| CH₄ | 0.159 | 0.6 |
| CO₂ | 0.003 | disregarded |
| NH₃ | 0.134 | 0.6 |
| H₂O | 0.061 | 0.3 |
| C₂H₆ | 0.001 | disregarded |
| Methyl borazine | 0.001 | disregarded |

FIG. 3 shows that the maximum specific impulse obtained, by injecting the gaseous product A (predominantly constituted of hydrogen) and the liquid oxidizer, composed of an aqueous solution of hydrogen peroxide containing 85% H₂O₂ by weight, into the combustion chamber, is 351 s, for a mix ratio between said liquid oxidizer and said gaseous product A (mix ratio referred to as OX/RED on the x-axis of said FIG. 3) of 7. The maximum specific impulse to within 2% is obtained for an extended range of the OX/RED mix ratio between 3 and 10. This is particularly advantageous, both from the point of view of the maximum impulse value attainable and regarding the low sensitivity to the mix ratio for obtaining a maximum impulse. It is not therefore necessary to have a fine control of the combustion chamber supply valves in order to reach the maximum specific impulse. Modulation of specific impulse starting from the maximum impulse value may advantageously be obtained by decreasing the OX/RED ratio, following the decreasing part of the specific impulse curve.

In comparison, a biliquid MMH/N₂O₄ mix has a narrow specific impulse peak, having a maximum level of 351 s, equivalent to that obtained according to the present example of the invention, the maximum level being obtained for an MMH/N₂O₄ mix ratio (mix ratio referred to as OX/RED on the x-axis of FIG. 1) of 2.33. The maximum specific impulse to within 2% is obtained for a narrow range of values of the mix ratio ranging from 1.83 to 2.69, followed on both sides by a rapid decrease of the specific impulse, which requires a fine control of the combustion chamber supply valves in order to obtain a target value of the specific impulse.

FIG. 4 shows that the combustion temperature obtained according to the present example of the invention does not exceed 2800 K whereas it reaches around 3361 K for the maximum specific impulse, in the case of an MMH/N₂O₄ biliquid mix. A lower combustion temperature makes it possible to reduce the constraints on the thermal resistance of the materials for the internal fittings of the combustion chamber and of the nozzle.

It is also advantageous to compare the performances obtained according to the present example of the invention with those of an aluminized composite propellant (68% by weight of ammonium perchlorate, 20% by weight of aluminum, 12% by weight of binder and additives). Such a propellant has a combustion temperature of 3558 K for a specific impulse of 329 s, under the operating conditions of the combustion chamber of the present example.

The present example therefore shows the advantage of the method of the invention which results in a maximum specific impulse, equivalent to that obtained according to the prior art (the closest prior art: MMH/N₂O₄), for a combustion temperature lower than according to said prior art, this being with products that are harmless for man and the environment.

### EXAMPLE 2

Example 2, even though it does not result in performance levels as advantageous as those obtained in example 1, shows the possibility of using another liquid oxidizer, in combination with the solid hydrogen generator compound of example 1, for implementing the method of the invention. The liquid oxidizer chosen for example 2 is N₂O₄.

The conditions of thermodynamic calculations of the ballistic performances are identical to those from example 1, especially as regards the gaseous products generated by said solid hydrogen generator compound (see the “gaseous product A” from table 1).

FIG. 3 shows that the maximum specific impulse obtained by injecting the gaseous product A of said solid compound and the liquid oxidizer N₂O₄ into the combustion chamber is 330 s for a mix ratio between the liquid oxidizer and the gaseous product A (mix ratio referred to as OX/RED on the x-axis of FIG. 3) of 1.78. FIG. 4 shows that the combustion temperature obtained according to the present example of the invention does not exceed 3271 K.

1. A propulsion method comprising:
the injection, into at least one combustion chamber, of at least one liquid oxidizer (OX) and of hydrogen (H₂);
the combustion of said at least one liquid oxidizer (OX) and hydrogen (H₂), in said at least one combustion chamber, for the generation of combustion gases; and
expulsion of said combustion gases;
characterized in that it comprises, upstream of said injection:
the generation of at least one portion of said hydrogen (H₂), advantageously of all said hydrogen (H₂), from at least one solid compound; said generation from said at least one solid compound comprising a combustion reaction between said at least one solid compound chosen from alkali metal borohydrides, alkaline-earth metal borohydrides, borazane, polyaminoboranes and mixtures thereof and an oxidizing charge.

2. The propulsion method as claimed in claim 1, wherein said oxidizing charge is chosen from Sr(NO₃)₂, ammonium dinitramide, NH₄ClO₄, NH₄NO₃ and mixtures thereof.

3. The propulsion method as claimed in claim 1, wherein the solid products generated, together with said hydrogen (H₂), are injected into said combustion chamber then expelled from said combustion chamber with said combustion gases.

4. The propulsion method as claimed in claim 1, wherein said at least one liquid oxidizer (OX) is chosen from aqueous solutions of nitric acid, hydrogen peroxide, nitrogen peroxide, hydroxylammonium nitrate, ammonium dinitramide, ammonium nitroformate and mixtures thereof.

5. The propulsion method as claimed in claim 1, wherein said at least one liquid oxidizer (OX) is a solution of hydrogen peroxide and wherein hydrogen (H₂), generated from said at least one solid compound (5′), is generated from borazane, combusted with an oxidizing charge.

6. The propulsion method as claimed in claim 1, which is carried out with thrust modulation.

7. The propulsion method as claimed in claim 6, wherein said thrust modulation is obtained by regulating the rate of injection of said at least one liquid oxidizer (OX) into said combustion chamber and/or the rate of injection of said hydrogen (H₂), generated from said at least one solid compound, into said combustion chamber.

8. A propulsion device comprising:
at least one combustion chamber equipped with at least one nozzle,
a device for supplying said at least one combustion chamber with at least one liquid oxidizer (OX),
a device for supplying said at least one combustion chamber with hydrogen (H₂);
wherein said device for supplying said at least one combustion chamber with hydrogen (H₂) comprises at least one hydrogen generator containing at least one solid compound chosen from alkali metal borohydrides, alkaline-earth metal borohydrides, borazane, polyaminoboranes and mixtures thereof and an oxidizing charge suitable for a combustion of said solid compound; said hydrogen generator being connected, on the one hand, to said at least one combustion chamber via a valve and, on the other hand, to the outside, via an advantageously controlled leakage means.

9. The device as claimed in claim 8, characterized in that said device for supplying said at least one combustion chamber with at least one liquid oxidizer (OX) comprises at least one pressurized tank that discharges via a valve.

10. The device as claimed in claim 9, wherein said at least one hydrogen generator is connected by means of a valve to said at least one tank so that the pressurization of said at least one tank is provided by a portion of said hydrogen (H₂) generated in said at least one generator.

11. A propulsion unit, the structure of which includes at least one device as claimed in claim 8.

12. The propulsion method as claimed in claim 4, wherein said at least one liquid oxidizer (OX) consists of an aqueous solution of hydrogen peroxide.

13. The propulsion method as claimed in claim 5, wherein said oxidizing charge consists of Sr(NO₃)₂.
